(19) United States
(12) Patent Application Publication
(10) Pub. No.: US 2026/0163928 A1
(43) Pub. Date: Jun. 11, 2026

(54) METHOD AND SYSTEM FOR MANAGING RICH COMMUNICATION SERVICE (RCS) BASED COMMUNICATION

(71) Applicant: Samsung Electronics Co., Ltd., Suwon-si (KR)

(72) Inventor: Suman TIWARI, Noida (IN)

(21) Appl. No.: 19/180,978

(22) Filed: Apr. 16, 2025

Related U.S. Application Data
(63) Continuation of application No. PCT/KR2025/004894, filed on Apr. 10, 2025.

(30) Foreign Application Priority Data
Aug. 7, 2024 (IN) 202411059718

(51) Int. Cl. H04L 65/1096; H04L 65/1069; H04L 65/1104; H04L 65/403

(52) U.S. Cl. CPC H04L 65/1096; H04L 65/1069; H04L 65/1104; H04L 65/403

(57) ABSTRACT

The present disclosure relates to a method and a system for managing a rich communication service (RCS) based communication in a multi-party call. The method comprises: determining a set of network capabilities for a current communication session and a rich communication service (RCS) session; sending a composer data comprising RCS information; determining one or more service configuration rules related to the composer data; and managing the RCS based communication based on the composer data and the one or more service configuration rules.

### CROSS-REFERENCE TO RELATED APPLICATIONS

This application is a continuation of International Application No. PCT/KR2025/004894 designating the United States, filed on Apr. 10, 2025, in the Korean Intellectual Property Receiving Office and claiming priority to Indian Complete patent application No. 202411059718, filed on Aug. 7, 2024, in the Indian Patent Office, the disclosures of each of which are incorporated by reference herein in their entireties.

### BACKGROUND

### Field

The disclosure relates to communication systems. For example, the disclosure relates to a method and system for managing a rich communication service (RCS) based communication.

### Description of Related Art

The following description of the related art is intended to provide background information pertaining to the field of the disclosure. This section may include certain aspects of the art that may be related to various features of the present disclosure. However, it should be appreciated that this section is used simply to aid in the understanding of the reader with respect to the present disclosure, and not as admissions of the prior art.

The traditional telephony services have been reshaped with the introduction of internet usage, leading to offering various features, enhanced quality of service (QoS), etc. These telephony services are offered to the users at minimal costs and therefore have gained even more ground. Thus, the internet protocol (IP)-based telephony services have succeeded the previous generations of non-IP based telephony services. These are particularly more useful in long distance communications. This IP-based telephony services mainly rely on converting voice information into data packets that can be transmitted over an IP network.

The IP-based telephony also offers users with convenience of accessibility of both voice as well as data services with the same user device and in the same session. This integration of data and voice services not only enables users to avail a number of services but is also responsible for enhancing the quality of these services.

In this direction, the Third Generation Partnership Project (3GPP) has defined a technology, e.g., the IP Multimedia Subsystem (IMS), to provide IP Multimedia services over mobile communication networks to further enhance the quality and features in communication services. These services provide a combination of voice, video, messaging, data, etc. within a same communication session. The IP Multimedia Subsystem (IMS) multimedia telephony service (MMTel) is mobile real-time multimedia communication that uses the media capabilities such as voice, real-time video, text, and/or multimedia messages (MMS). With MMTel, users can add and drop media during a communication session (or referred herein as a session). Moreover, with the MMTel the users in a communication session can start with chat, add voice (for instance Mobile Voice over Internet Protocol (VOIP)), add another caller, add video, share media and transfer files, and drop any of these without losing or having to end the session.

Rich Communication Service (RCS) is a service for rich, engaging messages for sending text, images, videos, and other multimedia content through their communication. This can be used with MMTel communication. RCS is best suited for non-streaming media (text, framed media) based communication. RCS capability discovery mechanisms enable users to discover a remote party's capability and availability for the communication at a particular moment. RCS allows multiple sessions with one or more users at any given time. The IMS network is booming in the communications fraternity and the features like rich communication services (RCS) being abundantly used, however the existing technology restricts a user to share RCS messages in a context of call (e.g. Pre-Call, Post Call, Caller's location information) with an intended target party at a receiving end if communication forwarding rules or other such rules have been enabled at the user device of a callee party.

In existing systems, when a calling subscriber tries to call a called subscriber, via the telephony server of the called subscriber, such call is not always answered by a user equipment of the called subscriber. It is, for instance, possible that the called subscriber is engaged in a previously established call, or is not reachable (such as, in case the user equipment is switched off). When the call from the calling subscriber towards the called subscriber is not answered, the calling subscriber may be connected to a voicemail system, or the call of the calling subscriber may get diverted or forwarded to another subscriber, or any such instance is possible. In such an instance, the call of the calling subscriber may be forwarded, but the RCS messages, if any, are not forwarded.

Thus, there exists a need for a technical solution that can address at least the above-mentioned technical limitations of the existing solutions. For example there is a need in the art to provide a method and system for managing a rich communication service (RCS) based communication.

The above information is presented as background information only to assist with an understanding of the disclosure. No determination has been made, and no assertion is made, as to whether any of the above might be applicable as prior art with regard to the disclosure.

### SUMMARY

Example embodiments of the present disclosure may relate to a method for managing a rich communication service (RCS) based communication. The method comprises: determining a set of network capabilities for a current communication session and a rich communication service (RCS) session; sending a multi-party composer data comprising RCS information and conference information; determining one or more service configuration rules related to the composer data; managing the RCS based communication based on the composer data and the one or more service configuration rules.

In an example embodiment of the present disclosure, the composer data specifies a desired action.

In an example embodiment of the present disclosure, the one or more service configuration rules are related to at least one of a composer service, a pre-call communication, and a post-call communication.

In an example embodiment of the present disclosure, the one or more service configuration rules comprises at least one of a call diversion rule, a call barring rule, a call line identity restriction rule, and a call waiting rule.

In an example embodiment of the present disclosure, the current communication session occurs among two or more user devices comprising at least a first user device, and a second user device, and wherein the set of network capabilities comprises one or more parameters indicating an ability of the two or more user devices for an establishment of the current communication session and the RCS session.

In an example embodiment of the present disclosure, the set of network capabilities are determined based on a performance of at least one of a query based technique and presence information based technique.

In an example embodiment of the present disclosure, the RCS information comprises at least one of an agenda related information, an urgency related information, and an image, and the conference information comprises at least one of a conference focus related information, a number of participants, a name of the participants, a conference time, a conference duration, one or more conference admin rules, one or more participation rules, and one or more RCS rules.

In an example embodiment of the present disclosure, the composer data is sent in a Session Initiation Protocol (SIP) REFER message.

In an example embodiment of the present disclosure, the method further comprises receiving a user response, in a Session Initiation Protocol (SIP) NOTIFY message, on at least one of the two or more devices.

According to an example embodiment of the present disclosure may relate to a method for managing a rich communication service (RCS) based communication in a multi-party call. The method comprises: detecting a communication session between a first user device and a second user device; determining a set of network capabilities for a concurrent communication session and a rich communication service (RCS) session; sending a multi-party call composer data comprising RCS information and conference information;

determining one or more service configuration rules related to the multi-party call composer data; and managing the RCS based communication in the multi-party call based on the multi-party call composer data and the one or more service configuration rules.

In an example embodiment of the present disclosure, the multi-party call composer data specifies at least one of a desired action.

In an example embodiment of the present disclosure, the multi-party call occurs among three or more user devices comprising at least a first user device, a second user device, and a third user device, and wherein the set of network capabilities comprises one or more parameters indicating an ability of the three or more user devices for an establishment of the concurrent communication session and the RCS session.

In an example embodiment of the present disclosure, the method comprises: sending a call invite to a fourth user device among the three or more user devices to establish a concurrent communication session with the fourth user device based on a service configuration rule among the one or more service configuration rules configured at the third user device.

In an example embodiment of the present disclosure, for establishing the concurrent communication session with the fourth user device, the method comprises initiating a communication for adding the fourth user device in the communication session between the first user device and the second user device.

In an example embodiment of the present disclosure, the method further comprises receiving a user response, in a Session Initiation Protocol (SIP) NOTIFY message, on at least one of the first user device, the second user device, and the third user device from the fourth user device, in response to the communication initiated for adding the fourth user device in the communication session.

In an example embodiment of the present disclosure, the multi-party call composer data is sent in a Session Initiation Protocol (SIP) REFER message.

In an example embodiment of the present disclosure, the set of network capabilities are determined based on a performance of at least one of a query based technique and presence information based technique.

In an example embodiment of the present disclosure, the RCS information comprises at least one of an agenda related information, an urgency related information, and an image, and the conference information comprises at least one of a conference focus related information, a number of participants, a name of the participants, a conference time, a conference duration, one or more conference admin rules, one or more participation rules, and one or more RCS rules.

Example embodiments of the present disclosure may relate to a system for managing a rich communication service (RCS) based communication. The system comprises: at least one processor, comprising processing circuitry, and a memory connected to at least one processor; wherein at least one processor, individually and/or collectively, is configured to cause the system to: determine a set of network capabilities for a current communication session and a rich communication service (RCS) session; send a composer data comprising RCS information; determine one or more service configuration rules related to the composer data; and manage the RCS based communication based on the composer data and the one or more service configuration rules.

Example embodiments of the present disclosure may relate to a non-transitory computer readable storage medium storing instructions for managing a rich communication service (RCS) based communication in a multi-party call. The instructions include executable code which, when executed by at least one processor, comprising processing circuitry, individually and/or collectively, of a system, causes the system to: determine a set of network capabilities for a current communication session and a rich communication service (RCS) session; send a composer data comprising RCS information; determine one or more service configuration rules related to the composer data; and manage the RCS based communication based on the composer data and the one or more service configuration rules.

Embodiments of the present disclosure provide manage a rich communication service (RCS) based communication in a multi-party call or in a single party call.

Embodiments of the present disclosure provide a system that is able to transmit a composer service communication or RCS with desired information such as location sharing communication comprising conference information to a new user that is added to a call session, wherein the call session may be a single party call session or a multi-party call session.

Embodiments of the present disclosure provide a solution that can determine the service configurations rules related to the composer service communication, pre-call communication, and post call communication, for managing a rich communication service (RCS) based communication in a multi-party call or in a single party call.

Embodiments of the present disclosure can determine the service configuration rules specifying a desired action using a communication message.

Embodiments of the present disclosure can enable transmission and receival of RCS messages at a remote device if a callee device has enabled communication forwarding rules for forwarding a call to the remote device.

### BRIEF DESCRIPTION OF THE DRAWINGS

The accompanying drawings, which are incorporated herein, and are a part of this disclosure, illustrate various example embodiments of the disclosed methods and systems in which like reference numerals refer to the same parts throughout the different drawings. Components in the drawings are not necessarily to scale, emphasis instead being placed upon clearly illustrating the principles of the present disclosure. Also, the various embodiments illustrated in the figures are not to be construed as limiting the disclosure, but the possible variants of the method and system according to the disclosure are illustrated herein to highlight the advantages of the disclosure. It will be appreciated by those skilled in the art that disclosure of such drawings includes disclosure of electrical components or circuitry commonly used to implement such components.

The above and other aspects, features and advantages of certain embodiments of the present disclosure will be more apparent from the following detailed description, taken in conjunction with the accompanying drawings, in which:

FIG. 1 is a block diagram illustrating an example configuration of a system for managing a rich communication service (RCS) based communication, according to various embodiments;

FIG. 2 is a block diagram illustrating an example configuration of a system comprising various modules/units for managing a rich communication service (RCS) based communication, according to various embodiments;

FIG. 3 is a flowchart illustrating an example method for managing a rich communication service (RCS) based communication, according to various embodiments;

FIG. 4 is a flowchart illustrating an example method for managing a rich communication service (RCS) based communication, according to various embodiments;

FIG. 5 is a signal flow diagram illustrating example operations for pre-call functionality for a user equipment while implementing a method for managing a rich communication service (RCS) based communication, according to various embodiments;

FIG. 6 is a signal flow diagram illustrating example operations for post-call functionality for a user equipment while implementing a method for managing a rich communication service (RCS) based communication, according to various embodiments;

FIGS. 7A and 7B are signal flow diagrams illustrating example operations of the calling service module for single party and multi-party calling according to various embodiments

FIG. 8 is a signal flow diagram illustrating example operations of the enriched calling service module according to various embodiments;

FIG. 9 is a signal flow diagram illustrating example operations while implementing a pre-call functionality in a method for managing a rich communication service (RCS) based communication, according to various embodiments;

FIG. 10 is a signal flow diagram illustrating example operations while implementing a post-call functionality in a method for managing a rich communication service (RCS) based communication, according to various embodiments;

FIG. 11 is a signal flow diagram illustrating example operations while implementing an In-call functionality in a method for managing a rich communication service (RCS) based communication, according to various embodiments;

FIG. 12A is a diagram illustrating an example single party call session scenario, according to various embodiments; and

FIG. 12B is a diagram illustrating an example multi-party call session scenario, according to various embodiments.

The same reference numerals are used to represent the same elements throughout the drawings.

### DETAILED DESCRIPTION

The terms and words used in the following description and claims are not be limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In various examples of the disclosure described below, a hardware approach will be described as an example. However, since various embodiments of the disclosure may include a technology that utilizes both the hardware-based and the software-based approaches, they are not intended to exclude the software-based approach.

In the following description, for the purposes of explanation, various specific details are set forth in order to provide an understanding of various example embodiments of the present disclosure. It will be apparent, however, that the example embodiments of the present disclosure may be practiced without these specific details. Several features described hereafter may each be used independently of one another or with any combination of other features. An individual feature may not address any of the problems discussed above or might address only some of the problems discussed above.

The description provides various example embodiments, and is not intended to limit the scope, applicability, or configuration of the disclosure. Rather, the description of the various example embodiments will provide those skilled in the art with an enabling description. It should be understood that various changes may be made in the function and arrangement of elements without departing from the spirit and scope of the disclosure.

Specific details are given in the following description to provide a thorough understanding of the various embodiments. However, it will be understood by one of ordinary skill in the art that the various embodiments may be practiced without these specific details. For example, circuits, systems, processes, and other components may be shown as components in block diagram form in order not to obscure the various embodiments in unnecessary detail.

It is noted that various embodiments may be described as a process which is depicted as a flowchart, a flow diagram, a data flow diagram, a structure diagram, a signal flow diagram or a block diagram. Although a flowchart may describe the operations as a sequential process, many of the operations may be performed in parallel or concurrently. In addition, the order of the operations may be re-arranged. A process may be terminated when its operations are completed but could have additional operations not included in a figure.

The word “exemplary” and/or “demonstrative” is used herein to refer, for example, to serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word-without precluding any additional or other elements.

As used herein, “a user equipment”, “a user device”, “a smart-user-device”, “a smart-device”, “an electronic device”, “a mobile device”, “a handheld device”, “a wireless communication device”, “a mobile communication device”, “a communication device” may refer to any electrical, electronic and/or computing device or equipment, capable of implementing the features of the present disclosure. The user equipment/device may include, but is not limited to, a mobile phone, smart phone, laptop, a general-purpose computer, desktop, personal digital assistant, tablet computer, wearable device or any other computing device which is capable of implementing the features of the present disclosure. The user device may contain at least one input means configured to receive an input from unit(s) which are required to implement the features of the present disclosure.

As used herein, “storage unit” or “memory unit” may refer to a machine or computer-readable medium including any mechanism for storing information in a form readable by a computer or similar machine. For example, a computer-readable medium includes read-only memory (“ROM”), random access memory (“RAM”), magnetic disk storage media, optical storage media, flash memory devices or other types of machine-accessible storage media. The storage unit stores at least the data that may be required by one or more units of the system to perform their respective functions.

As used herein “interface” or “user interface may refer to a shared boundary across which two or more separate components of a system exchange information or data. The interface may also be referred to a set of rules or protocols that define communication or interaction of one or more modules or one or more units with each other, which also includes the methods, functions, or procedures that may be called.

Various modules, units, components used herein, unless explicitly excluded herein, may be software modules or hardware processors, the processors being a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASIC), Field Programmable Gate Array circuits (FPGA), any other type of integrated circuits, etc.

Further, throughout the disclosure, an expression, such as e.g., ‘above’ or ‘below’ may be used to determine whether a specific condition is satisfied or fulfilled, but it is merely of a description for expressing an example and is not intended to exclude the meaning of ‘more than or equal to’ or ‘less than or equal to’. A condition described as ‘more than or equal to’ may be replaced with an expression, such as ‘above’, a condition described as ‘less than or equal to’ may be replaced with an expression, such as ‘below’, and a condition described as ‘more than or equal to and below’ may be replaced with ‘above and less than or equal to’, respectively. Furthermore, hereinafter, ‘A’ to ‘B’ means at least one of the elements from A (including A) to B (including B). Hereinafter, ‘C’ and/or ‘D’ means including at least one of ‘C’ or ‘D’, that is, {′C′, ‘D’, or ‘C’ and ‘D’}.

The disclosure describes various embodiments using terms used in some communication standards (e.g., 3rd Generation Partnership Project (3GPP), extensible radio access network (xRAN), open-radio access network (O-RAN) or the like), but it is only of an example for explanation, and the various embodiments of the disclosure may be easily modified even in other communication systems and applied thereto.

Pre-call functionality may refer to a feature where a user can compose information (e.g., a subject, location, picture, etc.) prior to placing the call for the other party to see. Such information is shared using multi-call composer service communication.

Post-call functionality may refer to a feature where a user can compose additional information (e.g., a reason note, or a voice message) when a call is rejected or unanswered, for the other side to view.

As discussed in the background section, existing technologies related to communication in a multi-party call have many limitations. For example, if a user equipment in a multi-party call, e.g., UE B is in communication with UE A, has activated “Call Forwarding” to UE C, then the MMTel call to UE B will get forwarded to UE C. However, RCS communications transmitted to UE B (such as, location shared to B) will not be transferred to UE C. In another example, when a first UE and a second UE are in a multi-party session, and if a new user is being added in to the session, the calling party goes into the hold mode or waiting until the new user joins the multi-party call, there is no control on Hold period or waiting period. In another example, when a first UE and a second UE are in a multi-party session, and if a new user is being added to the session or if that new user has activated IMS supplementary service configuration rule, the RCS communication service (call-composer, post call, live location etc.) cannot be transferred beyond that new user to intended user defined under configuration service (that is, if the new user has activated, for example, a supplementary service configuration rule to forward calls to a fourth user, then the RCS communication service cannot be transferred beyond that new user to intended fourth user). In another example, when a first UE and a second UE are in a multi-party session, and if a new user is being added to the session, the new user neither has enough information about conference (e.g. current participants, conference rules, agenda, duration etc.) nor the new user can communicate its preferences/rules during participation in conference.

In order to address at least some of the limitations of the prior known solutions, the present disclosure provides various example embodiments for managing a rich communication service (RCS) based communication in a multi-party call. Various embodiments may, for example, comprise detecting network capabilities for concurrent voice/video (e.g. multimedia telephony (MMTeL)) session and RCS session; transmitting a multi-call composer service communication or RCS with desired information or action from the first user equipment (UE), specifying the desired action. The multi-call composer service may include RCS information and conference information (such as, but not limited to, conference focus, number of participants, participants display names, time to join the conference, duration, admin rules, participation rules etc.). Further, based on determining the service configuration rules (such as, but not limited to, conference governing rules, call diversion rules, call barring, calling line identity (ID) restriction, call waiting etc.) related to the multi-call composer service communication, a communication message is sent from a caller party for a callee party that specifies the desired action. For the above purpose, the multi-call composer information may be shared using a REFER request/message, and participation preferences and such preference data may be shared using a NOTIFY message.

Hereinafter, various example embodiments of the present disclosure will be described in greater detail with reference to the accompanying drawings.

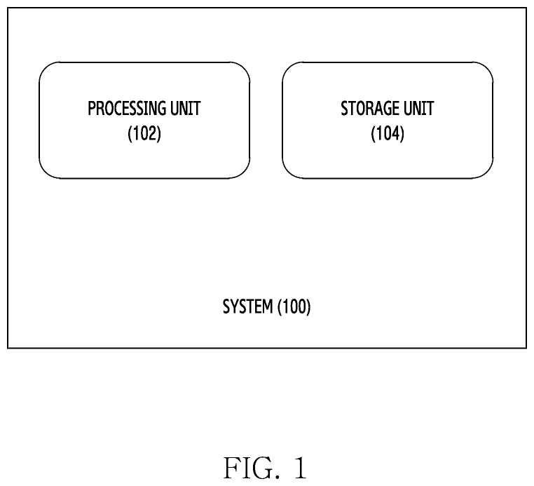

FIG. 1, is a block diagram illustrating an example configuration of a system [100] for managing a rich communication service (RCS) based communication, according to various embodiments. The system [100] may be configured for managing the rich communication service (RCS) based communication in a multi-party call or in a single party call. The system [100] comprises at least one processing unit (e.g, including various processing circuitry) [102], and at least one memory unit (e.g., including a memory) [104] (or as used herein, storage unit [104]). The components/units of the system [100] are assumed to be connected to each other unless otherwise indicated below. As shown in FIG. 1 units shown within the system [100] should also be assumed to be connected to each other. Also, in FIG. 1 a few units are shown, however, the system [100] may comprise multiple such units, or the system [100] may comprise any such numbers of said units, as required to implement the features of the present disclosure. Further, in an implementation, the system [100] may be connected to and/or in communication with a user device (may also be referred herein as a user equipment or a UE) to implement the features of the present disclosure. In another implementation, the system [100] may be connected to and/or in communication with a server end.

For example, for managing the RCS based communication in the multi-party call, the processing unit [102] may include various processing circuitry and may be initially configured to detect a communication session between a first user device and a second user device. In an implementation for managing the RCS based communication in the single party call, the communication session may not be existing, but initiated by one user device (e.g., the first user device) to another user device (e.g., the second user device). This communication session may be initiated between two parties or more than two parties. In an implementation, the communication session is initiated for one of a voice communication, a video communication, and a text communication, and wherein the communication session is initiated over one of a 4th generation communication network and a 5th generation communication network. Further for managing the RCS based communication in the single party call, the processing unit [102] is configured to determine a set of network capabilities for a current communication session and a rich communication service (RCS) session. In an implementation, current communication session may occur among two or more user devices comprising at least a first user device, and a second user device. The set of network capabilities comprises one or more parameters indicating an ability of the two or more user devices for an establishment of the concurrent communication session and the RCS session. In an implementation, a call invite may be sent to a third user device to establish a concurrent communication session with the third user device based on a service configuration rule among the one or more service configuration rules configured at the second user device. For example, a first user device, e.g., UE A, wants to initiate a communication session with a second user device, e.g., UE B, then the UE A sends a call invite to UE B. However, according to the service configuration rule at UE B, the call gets forwarded to a third user device, e.g., UE C. Thus, in an implementation, a user response, in a Session Initiation Protocol (SIP) NOTIFY message, may be received on at least one of the first user device, and the second user device, from the third user device, in response to the communication initiated for adding the third user device in the communication session. Pertinently, with the establishment of the communication session, the RCS session may also get established.

It will be understood that the processing unit [102] may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Where the call is a multi party call, the processing unit [102] may be configured to determine a set of network capabilities for a concurrent communication session and a rich communication service (RCS) session. In an implementation, the multi-party call occurs among three or more user devices comprising at least the first user device, the second user device, and a third user device, and the set of network capabilities comprises one or more parameters indicating an ability of the three or more user devices for an establishment of the concurrent communication session and the RCS session. In an implementation, a call invite may be sent to a fourth user device among the three or more user devices to establish a concurrent communication session with the fourth user device based on a service configuration rule among the one or more service configuration rules configured at the third user device. For establishing the concurrent communication session with the fourth user device a communication for adding the fourth user device in the communication session between the first user device and the second user device may be initiated. Further, in an implementation, a user response, in a Session Initiation Protocol (SIP) NOTIFY message, may be received on at least one of the first user device, the second user device, and the third user device from the fourth user device, in response to the communication initiated for adding the fourth user device in the communication session.

The set of network capabilities may be determined based on a performance of at least one of a query based technique and presence information based technique. Where the call is the single party call, the processing unit [102] may be configured to send a composer data comprising RCS information. In an implementation, the composer data is sent in a Session Initiation Protocol (SIP) REFER message, and specifies a desired action. The processing unit [102] may be configured to determine one or more service configuration rules related to the composer data. Where the call is a multi-party call, and the processing unit [102] may be configured to send a multi-party call composer data comprising RCS information and conference information. In an implementation, the multi-party call composer data is sent in a Session Initiation Protocol (SIP) REFER message, and specifies a desired action. The processing unit [102] may be configured to determine one or more service configuration rules related to the multi-party call composer data. In an implementation, the one or more service configuration rules are related to at least one of a composer service, a pre call communication, and a post call communication. In an implementation, the RCS information comprises at least one of an agenda related information, an urgency related information, and an image etc. The conference information comprises at least one of a conference focus related information, a number of participants, a name of the participants, a conference time, a conference duration, one or more conference admin rules, one or more participation rules, and one or more communication rules etc. The one or more service configuration rules may comprise at least one of a call diversion rule, a call barring rule, a call line identity restriction rule, and a call waiting rule etc. The processing unit [102] may be configured to manage the RCS based communication based on the composer data and the one or more service configuration rules. Where the call is a multi-party call, the processing unit [102] may be configured to manage the RCS based communication in the multi-party call based on the multi-party call composer data and the one or more service configuration rules.

In an implementation, where a user does not want to initiate a call session but wants to share RCS based communication with another user, but the another user has implemented a service configuration rule for forwarding the communication to a new user, the method facilitates sharing the RCS based communication with the new user based on the service configuration rule implemented by the another user. In this implementation, for managing the RCS based communication, the processing unit [102] may be configured to determine a set of network capabilities for a rich communication service (RCS) session. Further, in this implementation, the processing unit [102] is configured to send a composer data comprising RCS information. The processing unit [102] may be further configured to determine one or more service configuration rules related to the composer data. The RCS information may comprise at least one or more RCS rules along with other RCS information. The RCS rules may facilitate in forwarding the RCS based communication data to the new user if the another user has implemented the service communication rule(s). The processing unit [102] may be configured to manage the RCS based communication based on the composer data and the one or more service configuration rules. That is, based on the RCS rules implemented at, e.g., the another user to which the user wants to send an RCS communication, the RCS communication will be sent to the new user in case the service configuration rule and the RCS rule indicate forwarding the RCS based communication to the new user instead of the another user.

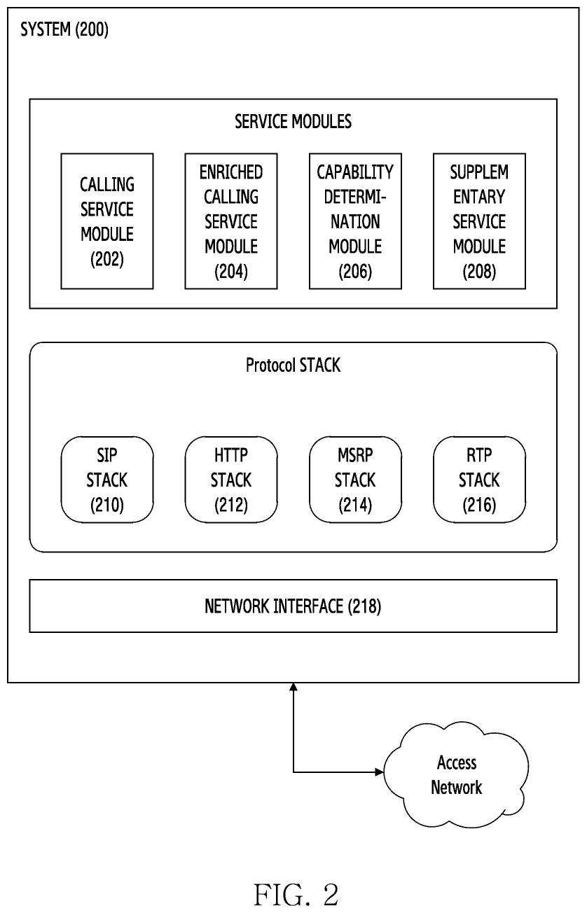

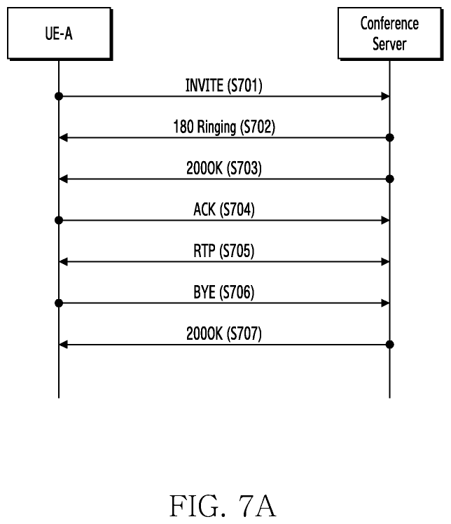

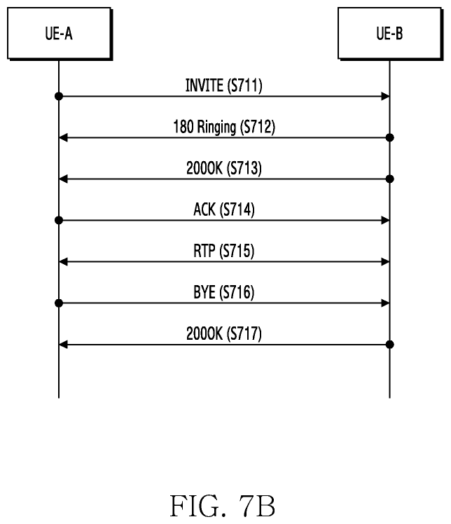

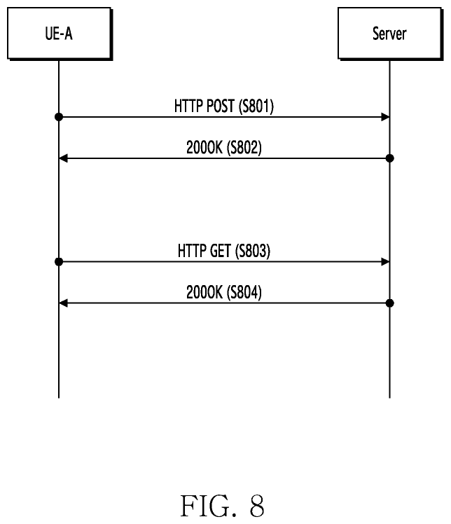

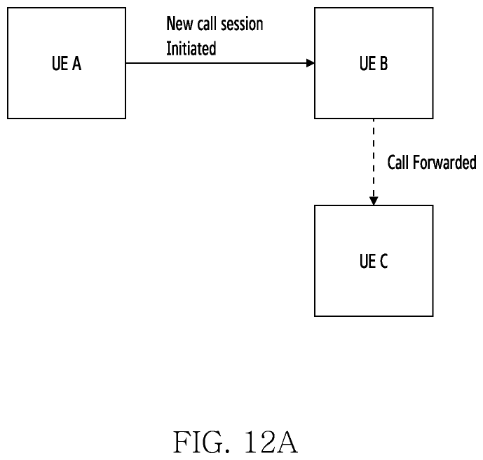

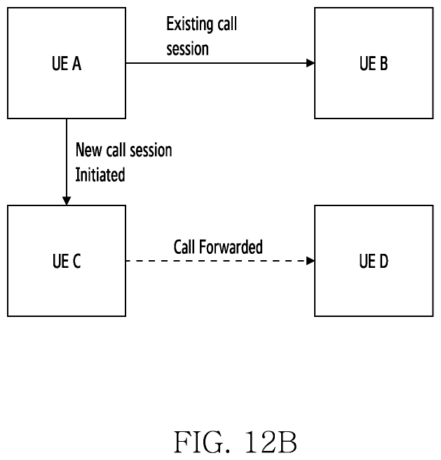

FIG. 2, is a block diagram illustrating an example configuration of the system [200] comprising various example modules for managing a rich communication service (RCS) based communication, according to various embodiments. The system [200], in an implementation, comprises the example modules/units/engines to implement one or more features of the present disclosure. These example modules as shown in FIG. 2, in an implementation, may be implemented by the processing unit [102] of the system [100]. As shown in FIG. 2, the system [200] comprises a calling service module [202], an enriched calling service module [204], a capability determination module [206], and a supplementary service module [208], each of which may include various circuitry and/or executable program instructions. The calling service module [202] may be responsible for creating and managing single party as well as multi-party voice and/or video calls (e.g., single party voice and/or video calls, and/or multi-party voice and/or video calls) session(s) for the user(s). A single-party call session may refer to a scenario where a call invite may be initiated by a first user device to a second user device. The call invite may be sent to a third user device to establish a concurrent communication session with the third user device based on a service configuration rule configured at the second user device. For example, referring to FIG. 12A that illustrates an example single party call session scenario, a first user device, e.g., UE A, wants to initiate a communication session with a second user device, e.g., UE B, then the UE A sends a call invite to UE B. However, according to the service configuration rule at UE B, the call gets forwarded to a third user device, e.g., UE C. A multi-party call session may refer to a scenario where there is an existing call session between two or more user devices, and one of those two or more user devices initiates a call invite to include a third user device in the existing call session. In this scenario, the call invite may be sent to a fourth user device to establish a concurrent communication session with the fourth user device based on a service configuration rule configured at the third user device. For example, referring to FIG. 12B that illustrates an example multi-party call session scenario, a first user device, e.g., UE A, and a second user device, e.g., UE B, are in a communication session with each other. Now, UE A wants to initiate a communication session with a third user device, e.g., UE C, then the UE A sends a call invite to UE C. However, according to the service configuration rule at UE C, the call gets forwarded to a fourth user device, e.g., UE D. These call sessions are based on session initiation protocol (SIP) and may thus be generally referred to as SIP sessions. Further, the calling service module [202] may be responsible for handling multimedia telephony (MMTel) based call composer information. Further details related to the calling service module [202] are provided with reference to FIG. 7. Further, the enriched calling service module [204] may be responsible for creating and managing rich communication service (RCS) based call-composer, in-call sessions, and post call sessions. The enriched calling service module [204] may also facilitate in uploading and/or downloading composer image content to/from an RCS content server using hypertext transfer protocol (HTTP) POST and GET procedures (the POST and GET procedures as generally known in the art). Further details related to this file upload and download procedures are provided with reference to FIG. 8 in this disclosure. The capability determination module [206] may be responsible for providing communication service capability information using Options based or Presence (PUBISH, SUBSCRIBE) information based mechanisms (the Options based or Presence based mechanisms as generally known in the art). Further, the supplementary service module [208] may be responsible for configuring and managing supplementary service rules (e.g. call forwarding, call barring etc.) for the user using HTTP GET and PUT procedures. These supplementary service rules may comprise service configuration rules such as, but not limited to, call management rules (such as, call barring, call waiting, call hold, and call forwarding behavior rules (such as call forward unconditional, call forward on busy, call forward on no reply, and call forward when unreachable) etc.), calling line identity (ID) restriction, terminating identification restriction, and connection number restriction, etc. In some implementations, the system [200] may be in communication with a UE which comprises a protocol stack and a network interface along with other components. The protocol stack may comprise a session initiation protocol (SIP) stack [210] (e.g., responsible for creating multi-media session between two end points, and for managing SIP transactions, sessions and dialogues), a hypertext transfer protocol (HTTP) stack [212] (e.g., responsible for creating and managing HTTP connection with server, and for handling GET, PUT and POST procedures), a Message Session Relay Protocol (MSRP) stack [214] (e.g., responsible for creating and managing MSRP connection between two end points, and for managing MSRP SEND, MSRP chunking etc.), and a real-time transport protocol (RTP) stack [216] (e.g., responsible for creating and managing RTP connection between two end points, and for managing audio/video stream flow). The network interface may be responsible for TCP/UDP/TLS (transmission control protocol/user datagram protocol/transport layer security) connections application programing interface (API), and for invoking APIs at system [200] to send request/responses.

In an implementation, the system [200] is connected to IMS infrastructure via the access network. The IMS infrastructure comprises Call Session Control Function (CSCF) server, home subscriber server (HSS), RCS Core application server, and MMTel core application server. The CSCF server is responsible for: serving IMS registration requests and creating a binding for user authentication of user, and for serving the service session SIP requests and invoking respective application servers. The HSS comprises a subscriber database that stores information related to subscriber identities, and subscriber service configurations. The RCS Core application server further comprises an enrich call application server (AS), a capex AS, and a file transfer (FT) content AS. The enrich call AS is responsible for serving pre-call, post-call and in-call SIP session INVITE requests, and managing MSRP media flow for pre-call, post-call and In-call sessions. The capex AS is responsible for serving capability fetch request (OPTIONS/SUBSCRIBE) to query remote user's service availability, and for providing remote user's capability in SIP 200OK/NOTIFY. The FT content AS is responsible for serving file content upload (HTTP POST) and providing content resource link in 200OK to user, and file content download request (HTTP GET) and providing file content in 200OK to user. The MMTel core AS comprises a MMTel AS, a supplementary AS, and a MMTel Conference AS. The MMTel AS is responsible for serving voice call and video call session INVITE requests, managing RTP stream flow during the call, and identifying the service configuration rules applicable on user and taking actions accordingly. The supplementary AS is responsible for serving HTTP GET request and provide the current call service configuration to user, and for serving HTTP PUT request to update the call service configuration for the user. The MMTel conference AS is responsible for serving conference INVITE requests and communicating conference focus reference to user in 200OK, managing the participant joining status, subscribe request and activating subscription to generate NOTIFY about other participant joining/leaving status.

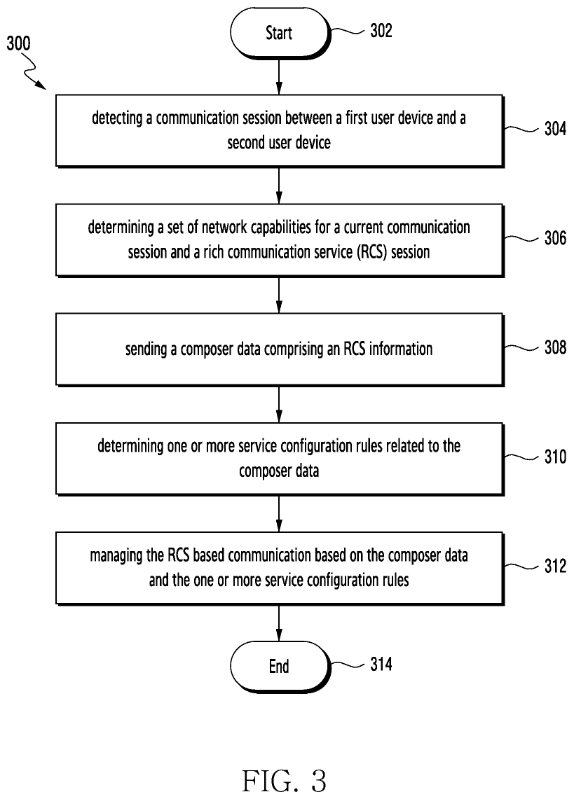

FIG. 3 is a flowchart illustrating an example method [300] for managing a rich communication service (RCS) based communication, according to various embodiments. In an implementation, the method [300] may be performed by the system [100]. In an implementation the method [300] may be performed by the system [200] independently or by the system [200] with the help of system [100]. As shown in FIG. 3, the method [300] may start at step 302, and goes to step 304. It may be understood that the method [300] may be triggered at step 302 where a user may try to add a new user in a multi-party call or while initiating a call session.

At step 304, in a multi-party call scenario, the method comprises detecting a communication session between a first user device and a second user device. This step may not occur in a scenario where a user is trying to initiate a communication session with another user, that is, in a single party call as explained above in this disclosure. However, for a multi-party call session, for example, UE A is engaged in a session (e.g. call or messaging) using a 4G/5G network with the UE B. In this example, the processing unit [102] may detect the communication between the first UE and the second UE, which is an enhanced communication, that is, for example, a MMTel session along with an RCS session, established between UE A and UE B. Thus, in an implementation, the communication session is initiated for one of a voice communication, a video communication, and a text communication, and wherein the communication session is initiated over one of a 4th generation communication network and a 5th generation communication network. Now, for example, for adding a new UE, e.g., UE C, in the call/session, UE A sends an invitation in order to establish the MSRP session with UE C.

At step 306, the method comprises determining a set of network capabilities for a current communication session and a rich communication service (RCS) session. In case it is determined that the network as well as the user devices are capable of implementing a MMTel session as well as the RCS session, a composer content (a multi-call composer content) may be uploaded at HTTP server/RCS server and a resource link is obtained from the RCS server. In an implementation, the current communication session occurs among two or more user devices comprising at least a first user device, and a second user device, and the set of network capabilities comprises one or more parameters indicating an ability of the two or more user devices for an establishment of the current communication session and the RCS session. In an implementation, the multi-party call occurs among three or more user devices comprising at least the first user device, the second user device, and a third user device. In an implementation, the set of network capabilities comprises one or more parameters indicating an ability of the three or more user devices for an establishment of the concurrent communication session and the RCS session. For example, UE A is engaged in a session (e.g. call or messaging) using a 4G/5G network with the UE B, and for adding a new UE, e.g., UE C, in the call session, UE A sends an invitation in order to establish the MSRP session with UE C. Now, for example, the UE C has set up one or more configuration rules, such as, but not limited to, a call diversion rule, a call barring rule, a call line identity restriction rule, and/or a call waiting rule. Here, the call diversion rule may refer to diverting the incoming calls from some specific or all numbers to another UE (that is, to another subscriber identity module (SIM) number that may be used by another UE), the call barring rule may refer to barring the calls coming from some specific or all numbers, the call line identity restriction rule may relate to restricting an incoming calls from numbers of some specific calling lines, the call waiting rule may refer to a case where an incoming call is put on hold when the UE is busy with a call with some other UE. For example, in the above example, the rule is to forward the incoming call to another UE, e.g., UE D, when any of these rules is implemented at UE C. Thus, in an implementation, a call invite may be sent to a fourth user device among the three or more user devices to establish a concurrent communication session with the fourth user device based on a service configuration rule among the one or more service configuration rules configured at the third user device. For establishing the concurrent communication session with the fourth user device, a communication for adding the fourth user device in the communication session between the first user device and the second user device may be initiated. Also, the set of network capabilities may be determined based on a performance of at least one of a query based technique (e.g., option based technique) and presence information based technique.

At step 308, the method comprises sending a composer data comprising RCS information. In an implementation, the composer data is sent in a Session Initiation Protocol (SIP) REFER message, and specifies a desired action. In case of a multi-party call session, the method comprises sending a multi-party call composer data comprising RCS information and conference information. In an implementation, the composer data or the multi-party call composer data is sent in a Session Initiation Protocol (SIP) REFER message, and specifies a desired action.

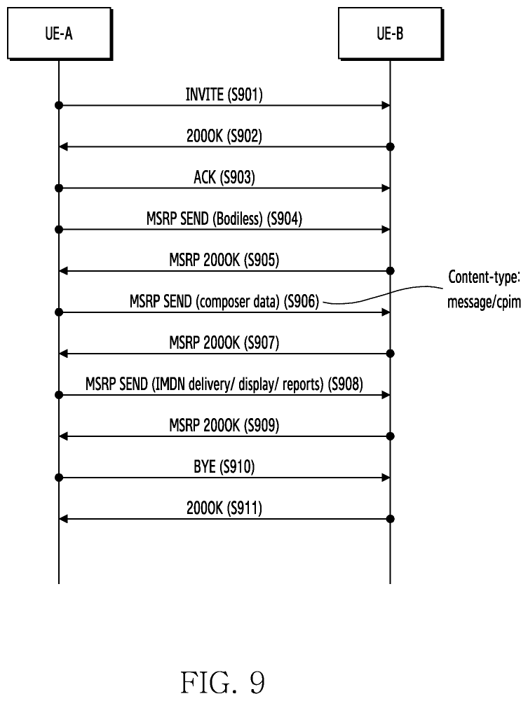

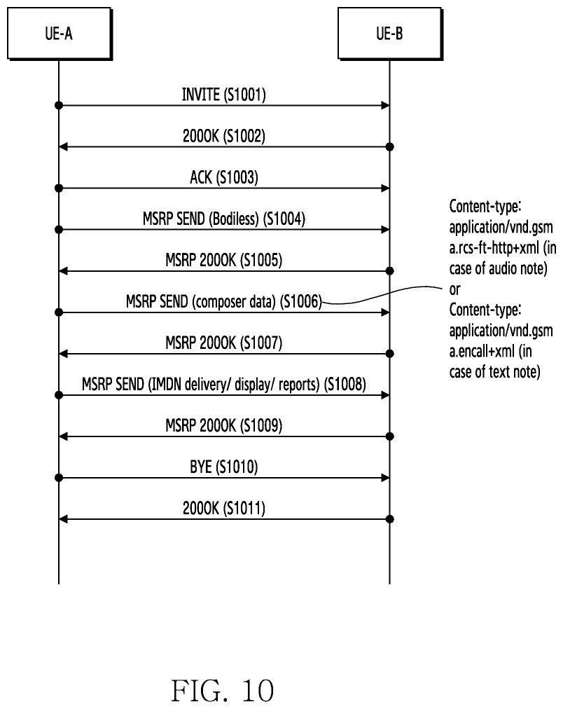

At step 310, the method comprises determining one or more service configuration rules related to the composer data. In case of a multi-party call session, the method comprises determining one or more service configuration rules related to the multi-party call composer data. In an implementation, the one or more service configuration rules are related to at least one of a composer service, a pre call communication, and a post call communication. A more detailed description of the pre call communication and the post call communication is provided below with reference to FIGS. 9 and 10, respectively.

In an implementation, the RCS information comprises at least one of an agenda related information, an urgency related information, and an image etc. The conference information comprises at least one of a conference focus related information, a number of participants, a name of the participants, a conference time, a conference duration, one or more conference admin rules, one or more participation rules, and one or more communication rules etc. The one or more service configuration rules may comprise at least one of a call diversion rule, a call barring rule, a call line identity restriction rule, and a call waiting rule etc.

The multi-call composer data comprises conference information (such as, but not limited to, conference focus, participant details, agenda, urgency, call composer data), host governing rules (such as, but not limited to, admin rights, participation control rules, call expiry time, time to join, speaker mode/listener mode, allow to add remote participants etc.), recipient's participation rules (such as, but not limited to, user's privacy, time of joining, auto exit rules, connected party information etc.).

Continuing with the above example in case of multi-party call, for example the network and the UEs may be determined as capable of implementing MMTel session and RCS session. Also, for example the UE C has implemented one of the service configuration rules. When the UE A tries to establish a session with UE C, that is, to add UE C in the existing session of UE A and UE B, then the REFER message is sent to UE C. This REFER message specifies the desired action that is performed by UE C, that is, according to the service configuration rule implemented at UE C. For example, the UE C has implemented a rule of call forwarding to UE D. As a result of this REFER message being included when the UE A adds UE C in the existing call session of UE A and UE B, the RCS communication can now be sent to UE D. Thus, in this example, the UE D may obtain the composer content uploaded at the HTTP server and the resource link from the RCS server using the HTTP GET request. In an implementation, some or all of the composer data or the multi-party call composer data may be displayed on the user interface (UI) of the user device of one or more participants of the call session.

In an implementation, the method further comprises receiving a user response, in a Session Initiation Protocol (SIP) NOTIFY message, on at least one of the two or more devices. Further, in an implementation, in a multi-party call scenario, a user response, in a Session Initiation Protocol (SIP) NOTIFY message, may be received on at least one of the first user device, the second user device, and the third user device from the fourth user device, in response to the communication initiated for adding the fourth user device in the communication session. The final new user (UE D in the above example), that is, the user that is being added to the existing multi-party call session as a result of service configuration rule at the new user (UE C in the above example of the multi-party call scenario) acts on the conference invitation and sends NOTIFY message for instance to the first user (UE A in the above example of the multi-party call scenario) comprising end user response, user's conference participation rules, privacy rules, connected party information, and/or joining duration etc.

Thus, at step 312, the method comprises managing the RCS based communication in the single party call based on the composer data and the one or more service configuration rules. In the multi-party call scenario, the method comprises managing the RCS based communication in the multi-party call based on the multi-party call composer data and the one or more service configuration rules. As a result, the information of the connected user (UE D in the above example of the multi-party call scenario) is also transmitted/shared with other users in the call session for further RCS communication (e.g. location data, etc.) to the connected user (UE D in the above example of the multi-party call scenario).

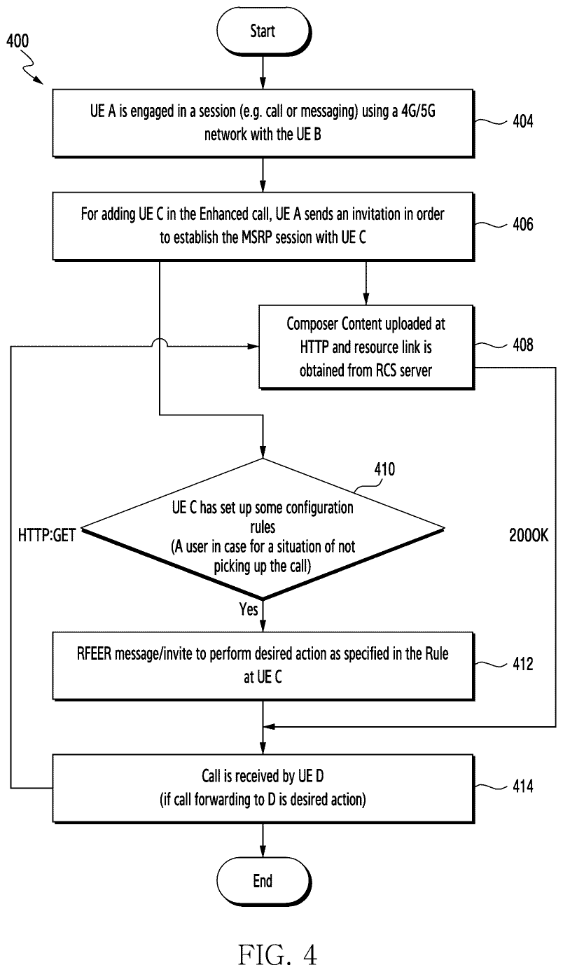

FIG. 4, is a flowchart illustrating an example method [400] for managing a rich communication service (RCS) based communication in a multi-party call, according to various embodiments. As shown in FIG. 4, at block 404, the UE A is engaged in a session (e.g. call or messaging) using a 4G/5G network with the UE B. At block 406, for adding UE C in the existing call session between UE A and UE B, UE A sends an invitation in order to establish the MSRP session with UE C. As shown in block 410, it is checked if the UE C has set up some configuration rules (for example, a user in case for a situation of not picking up the call). In case the UE C has set up some configuration rules, then the RFEER message/invite to perform desired action as specified in the Rule at UE C is sent as shown at block 412. At block 414, call is received by UE D (in an example where the UE C has set up configuration rule of forwarding the call to UE D, that is, call forwarding to UE D is the desired action). Based on this, as shown at block 408, the UE D may send HTTP GET request for obtaining the multi-call composer content uploaded at the HTTP server and the resource link from the RCS server, and the content is shared with UE D in response (200 OK) to the HTTP GET request.

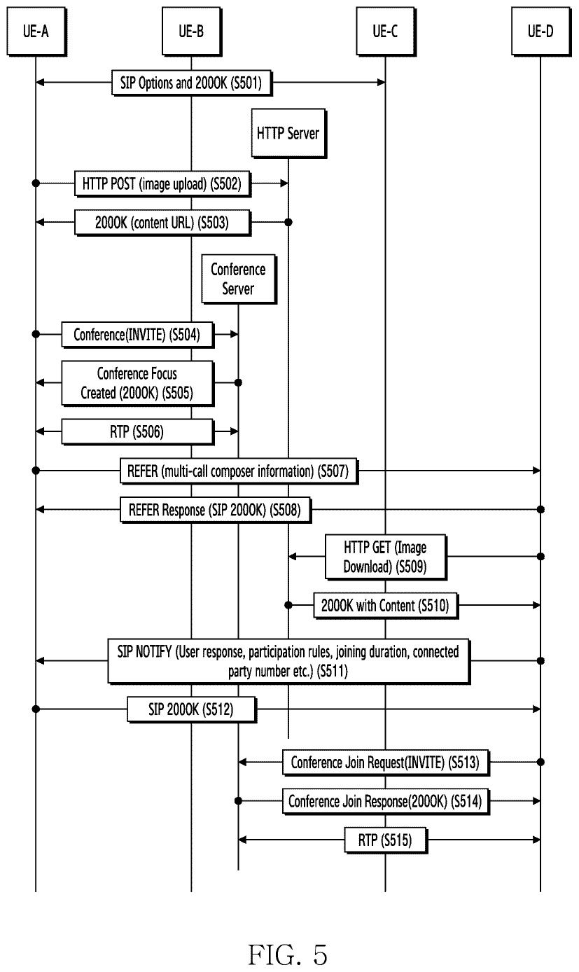

FIG. 5 is a signal flow diagram illustrating example pre-call functionality for a user equipment while implementing a method for managing a rich communication service (RCS) based communication in a multi-party call, according to various embodiments. As shown in FIG. 5, at S501, SIP Options and response 200OK may be shared between UE A and UE C, when UE A tries to establish a session with UE C while being in an existing session with UE B. UE A defines the call composer content. As shown at S502, the multi-call composer content is to be uploaded at HTTP server. For this purpose, the multi-call composer image is uploaded at the HTTP server via a HTTP POST request. A resource link is obtained from the HTTP server at S503 in response 200OK. Conference information is shared in an INVITE message sent from UE A to the conference server at S504. As a result, a conference focus is created and information is shared with UE A by the conference server at S505 in response 200OK to the INVITE message. With this, the need to create and manage the call composer SIP session, as well as the MMTel one-to-one SIP Session is eliminated. Real time transport protocol (RTP) message is sent by the UE A to the conference server as shown at S506. At S507, a REFER message comprising the multi-call composer information is shared by UE A with UE D as the UE C has implemented service configuration rule to forward the call to UE D (in case of single party call, the REFER message comprises the composer data). In response to this, the UE D sends REFER Response message in SIP 200OK to UE A as shown at S508. As shown at S509, the UE D sends a HTTP GET message to HTTP server to obtain the multi-call composer content uploaded at HTTP server. As shown at S510, the HTTP server sends to UE D, response 200OK along with the content requested by UE D. At S511, the UE D sends SIP NOTIFY message to UE A which comprises a user response, participation rules, joining duration, connected party number, etc. related to UE D. This is a notification that the UE D is presented with the multi-call composer content. In response to this SIP NOTIFY message, the UE A sends a SIP 200OK to UE D at S512. The UE D sends a conference join request in an INVITE message to the conference server at S513. At S514, the conference server sends 200OK to UE D in response to the conference join request. Finally, the UE D is able to share RTP packets with the conference server as shown at S515. Further details with respect to this functionality have been provided with reference to FIG. 9 below.

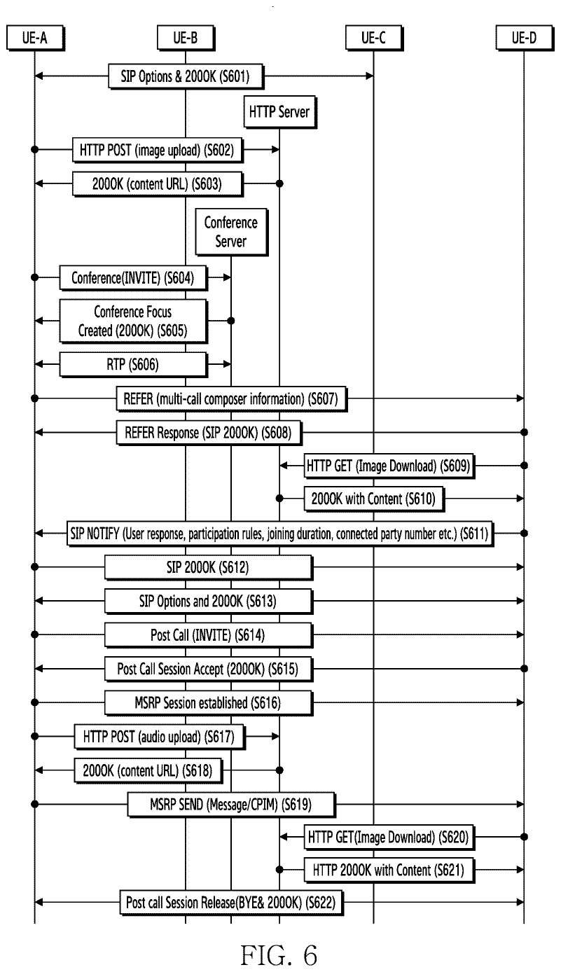

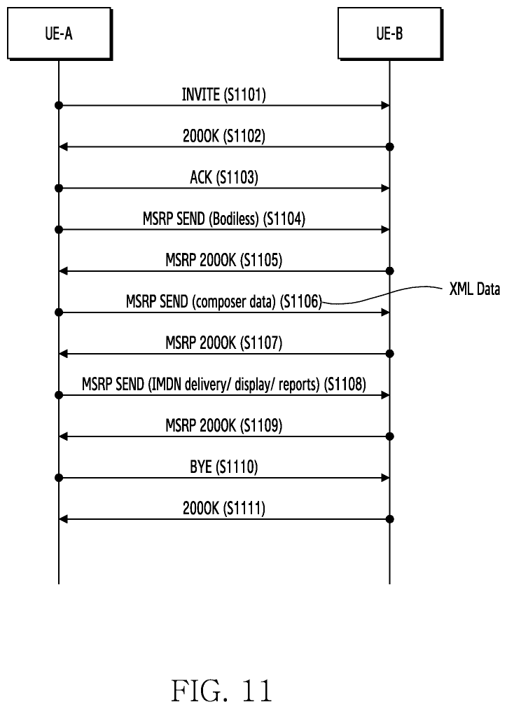

FIG. 6 is a signal flow diagram illustrating example post-call functionality for a user equipment while implementing a method for managing a rich communication service (RCS) based communication in a multi-party call, according to various embodiments. As shown in FIG. 6, at S601, SIP Options and response 200OK may be shared between UE A and UE C, when UE A tries to establish a session with UE C while being in an existing session with UE B. UE A defines the call composer content. As shown at S602, the multi-call composer content is to be uploaded at HTTP server. For this purpose, the multi-call composer image is uploaded at the HTTP server via a HTTP POST request. A resource link is obtained from the HTTP server at S603 in response 200OK. Conference information is shared in an INVITE message sent from UE A to the conference server at S604. As a result, a conference focus is created and information is shared with UE A by the conference server at S605 in response 200OK to the INVITE message. With this, the need to create and manage the call composer SIP session, as well as the MMTel one-to-one SIP Session is eliminated. Further, RTP message is sent by the UE A to the conference server as shown at S606. At S607, a REFER message comprising the multi-call composer information is shared by UE A with UE D as the UE C has implemented service configuration rule to forward the call to UE D. In response to this, the UE D sends REFER Response message in SIP 200OK to UE A as shown at S608. As shown at S609, the UE D sends a HTTP GET message to HTTP server to obtain the multi-call composer content uploaded at HTTP server. As shown at S610, the HTTP server sends response to UE D, 200OK along with the content requested by UE D. At S611, the UE D sends SIP NOTIFY message to UE A which comprises a user response, participation rules, joining duration, connected party number, etc. related to UE D. In response to this SIP NOTIFY message, the UE A sends a SIP 200OK to UE D at S612. At S613, SIP Options and response 200OK are shared between UE A and UE D for the post call capability detection. At S614, a post call INVITE message is sent by UE A to UE D which may define a post call audio note. Further, at S615, the UE D sends a post call session accept in response 200OK to UE A. Thus, at S616, the MSRP session is established between UE A and UE D, and a relevant information may be shared by UE A with UE D with this session establishment. At S617, UE A sends a HTTP POST request to the HTTP server for an audio upload at the HTP sever related to the post-call functionality. In response to this request, the HTTP server sends content uniform resource locator (URL) to the UE A in response 200OK at S618. The UE A sends a MSRP SEND message for sending a message/Common Presence and Instant Messaging (CPIM) message to UE D at S619. At S620 the UE D sends HTTP GET request to HTTP server for image download from the HTTP server. In response to this HTTP GET request, the HTTP server sends the requested content to the UE D in the response 300OK at S621. With this, the post call audio note is downloaded and presented to the UE A, and finally, the post call session is released with the BYE and 200OK messages at S622. Further details with respect to this functionality have been provided with reference to FIG. 10 below. The user equipment also facilitates an In-call functionality, the details of which are provided with reference to FIG. 11 below.

FIGS. 7A and 7B are signal flow diagrams illustrating example functionality of the calling service module [202] for single party and multi-party calling according to various embodiments. In an implementation, the calling service module [202] implements MMTel service protocol, and implements procedures to start call, hold call, resume call, add other party to call, disconnect the call etc. Further, the calling service module [202] manages the ongoing call state information. The calling service module [202] may comprise a single party call manager (functionality of which is shown in FIG. 7B) and a multi-party call manager (functionality of which is shown in FIG. 7A). Single Party Call Manager handles the request to start and manage the call with one remote party. For multi-party calls, the multi-party call manager handles the request to start and manage the conference call, processes the conference focus received from server, adding/removing participants, subscription to conference focus to receive the participant's joining status. Conference focus information is received in 200OK response to the INVITE message. For clarity, the procedure followed by multi-party call manager is explained with reference to FIG. 7A. As shown in FIG. 7A, at S701, an example user equipment UE A sends INVITE message to conference server for multi-party call. At S702, the conference server sends 180 Ringing and response 200OK at S703. This response 200OK comprises a conference focus identity. At S704, the UE A sends an Acknowledgement message to the conference server. RTP packets are exchanged between UE A and conference server at S705. At S706, BYE message is sent by UE A to the conference server, and the conference server sends response 200OK at S707.

In single-party call, as shown in FIG. 7B, at S711, an example user equipment UE A sends INVITE message to UE B for single-party call. At S712, the UE B sends 180 Ringing and response 200OK at S713. This response 200OK does not comprise a conference focus identity as was there in multi-party call. At S714, the UE A sends an Acknowledgement message to the UE B. Further, RTP packets are exchanged between UE A and UE B at S715. At S716, BYE message is sent by UE A to the UE B, and the UE B sends response 200OK at S717.

FIG. 8 is a signal flow diagram illustrating example functionality of the enriched calling service module [204] according to various embodiments. Enriched Calling Service is RCS service to provide enriched information (e.g., RCS based communication) in the context of call while connecting/disconnecting and during the voice/video call. The enriched calling Service module [204] is an implementation of: RCS File upload/download procedures, RCS pre-call, post-call and in-call functionalities. The enriched calling service module [204] may facilitate in uploading and/or downloading composer image content to/from an RCS content server using hypertext transfer protocol (HTTP) POST and GET procedures. As shown in FIG. 8, at S801, for RCS File upload, the UE A sends HTTP POST message to the server (e.g., the RCS content server), in response to which the server sends 200OK at S802. For RCS File download, the UE A sends HTTP GET request to the server at S803, in response to which the server sends 200OK with which the file data is received at the UE A at S804.

FIG. 9 is a signal flow diagram illustrating an example procedure while implementing a pre-call functionality in a method for managing a rich communication service (RCS) based communication in a multi-party call, according to various embodiments. In the pre-call functionality, a user can compose information (by including a subject, location, picture, etc.) prior to placing the call such that the other side is able to see the composed pre-call information while receiving the incoming call. Further, the user creates MSRP based SIP session with a remote party, and shares this composer information. As shown in FIG. 9, at S901, the UE A sends INVITE message to UE B, in response to which, the UE B sends 200OK to UE A at S902. Further, the UE A sends Acknowledgement message to UE B at S903, and sends MSRP SEND message at S904. In response to the MSRP SEND message, the UE B sends 200OK at S905 and the image is uploaded at the RCS content serve using the procedures mentioned with respect to FIG. 8. At S906, the UE A sends MSRP SEND request to UE B. This MSRP SEND message is associated with a “Content-type: message/cpim”, where the message/cpim contains (application/vnd.gsma.encall+xml) data. In response to this, the UE B sends response 200OK at S907, and the image is downloaded from the RCS content server using the procedures mentioned with respect to FIG. 8. At S908, the UE B sends MSRP SEND message for Instant Message Disposition Notification (IMDN) delivery, and display reports, in response to which the UE A sends 200OK at S909. The UE A sends BYE message to UE B at S910, in response to which the UE B sends 200OK to UE A at S911.

FIG. 10 is a signal flow diagram illustrating an example procedure while implementing a post-call functionality in a method for managing a rich communication service (RCS) based communication in a multi-party call, according to various embodiments. In the post-call functionality, if a call is unanswered, the user can choose to either leave a note (reason) or a voice message to send to the receiving side. The user creates MSRP based SIP session with remote party and share the audio link/text note. As shown in FIG. 10, at S1001, the UE A sends INVITE message to UE B, in response to which, the UE B sends 200OK to UE A at S1002. The UE A sends Acknowledgement message to UE B at S1003, and sends MSRP SEND message at S1004. In response to the MSRP SEND message, the UE B sends 200OK at S1005 and the image is uploaded at the RCS content server using the procedures mentioned with respect to FIG. 8. At S1006, the UE A sends MSRP SEND request to UE B. This MSRP SEND message is associated with a “Content-type: application/vnd.gsma.rcs-ft-http+xml (in case of audio note)” or “Content type: application/vnd.gsma.encall+xml (in case of text note)”. In response to this, the UE B sends response 200OK at S1007, and the audio file is downloaded from the RCS content server using the procedures mentioned with respect to FIG. 8. At S1008, the UE B sends MSRP SEND message for Audio note/text note information, in response to which the UE A sends 200OK at S1009. The UE A sends BYE message to UE B at S1010, in response to which the UE B sends 200OK to UE A at S1011.

FIG. 11 is a signal flow diagram illustrating an example procedure while implementing an In-call functionality in a method for managing a rich communication service (RCS) based communication in a multi-party call, according to various embodiments. In the in-call functionality, a user can share content during a call: chat, files (or group of files like presentations), location, background audio, video, shared map, shared sketch. Further, in the in-call functionality, all other in-call services except shared map and shared sketch follow usual RCS chat and file transfer procedures. Shared Map is an application that lets two users draw, share markers, view each other positions on a “shared” map. Shared Sketch is an application that lets two users draw, add background images, change background colour on a “shared” canvas. Like other RCS messaging sessions, shared map and shared sketch also create MSRP based SIP session to communicate the markups and drawings between two parties. As shown in FIG. 11, at S1101, the UE A sends INVITE message to UE B, in response to which, the UE B sends 200OK to UE A at S1102. This INVITE message is associated with a shared map and a shared sketch. The UE A sends Acknowledgement message to UE B at S1103, and sends MSRP SEND message at S1104. In response to the MSRP SEND message, the UE B sends 200OK at S1105 and the image is uploaded at the RCS content serve using the procedures mentioned with respect to FIG. 8. At S1106, the UE A sends MSRP SEND request to UE B. This MSRP SEND message is associated with an XML data. In response to this, the UE B sends response 200OK at S1107, and the image is downloaded from the RCS content server using the procedures mentioned with respect to FIG. 8. At S1108, the UE B sends MSRP SEND message for IMDN delivery, and display reports, in response to which the UE A sends 200OK at S1109. The UE A sends BYE message to UE B at S1110, in response to which the UE B sends 200OK to UE A at S1111.

In accordance with various example embodiments of the present disclosure, the Options based mechanism uses SIP Options methods to exchange service capability information. In this, an example user equipment UE A sends an OPTIONS message to another example user equipment UE B, and in response to the OPTIONS message, the UE B sends 200OK to UE A. In this OPTIONS message and the 200OK message, the service capability feature tags are communicated in contact header.

In accordance with various example embodiments of the present disclosure, the presence server based mechanism uses publish and subscribe procedures. In this, a UE publishes self service capability to presence server. Further, the UE subscribes to remote's service capability. The Presence server uses Presence Information Data Format (PIDF) Multipurpose Internet Mail Extension (MIME) type for communication. The UE A sends PUBLISH message to Presence Server, in response to which the presence server sends 200OK. Further, the UE A sends SUBSCRIBE message to Presence Server, in response to which the presence server sends 200OK. Also, the presence server sends NOTIFY message to UE A notifying the capability of the remote UE, in response to which the UE A sends 200OK.

In accordance with various example embodiments of the present disclosure, supplementary service module [208] comprising a XML Configuration Access Protocol (XCAP) manager/server, may be responsible for configuring and managing supplementary service rules (e.g. call forwarding, call barring etc.) for the user using HTTP GET and PUT procedures. The UE A sends a HTTP GET message to the XCAP server for fetching current service configuration status of a remote device, in response to which the XCAP server sends 200OK. The UE A sends a HTTP PUT message to the XCAP server for setting or updating a service configuration status of a remote device, in response to which the XCAP server sends 200OK.

In accordance with various example embodiments of the present disclosure, the SIP stack is implementation of SIP protocol. The SIP may be a signalling used for initiating, maintaining, and terminating communication sessions that include voice, video and messaging between two end points. The UE A sends an INVITE message to UE B. Further, the UE B sends 180 Ringing message to UE A along with response 200OK to UE A. Further, the UE A sends an ACK acknowledgement message to UE B, and the media session is established between UE A and UE B. Further, the UE A send BYE message to UE B, and the UE B sends 200OK to UE A in response to the BYE message.

In accordance with various example embodiments of the present disclosure, the HTTP stack [212] is implementation of HTTP protocol. HTTP is an application protocol in the internet protocol model for distributed, collaborative, hypermedia information systems. According to the implementations of the present disclosure, HTTP stack is used for RCS File upload/download procedures and Supplementary services. The UE A sends a HTTP POST message to the server, e.g., the HTTP server, which is used to upload content to the server. In response, the server sends 200OK to the UE A. The resource link is created for content and shared in this 200OK response. The server sends HTTP GET message to the UE A, in response to which the UE A sends 200OK. This HTTP GET is used to download the content from server. The UE A sends HTTP PUT message to the server at S1605. HTTP PUT is used to update the resource content at server. Further, the server sends 200OK in response to this HTTP PUT message. Further, the UE A sends HTTP DELETE message, which is used to delete the content from the server. In response to this, the server sends 200OK message to the UE A.

In accordance with various example embodiments of the present disclosure, the MSRP stack [214] is implementation of MSRP protocol. Message Session Relay Protocol (MSRP) is a protocol for transmitting a series of related instant messages in the context of a communications session. MSRP is used in the RCS context, especially for the instant messaging, file transfer, location sharing features, enriched calling etc. The UE A sends a MSRP SEND message to UE B. This MSRP SEND message carries the application data like messages, user level delivery/display reports. Further, the UE B sends 200OK in response to the MSRP SEND message. The UE B sends MSRP REPORT message to UE A. The MSRP REPORT message carries Acknowledgement about the data received e.g. transaction failed, successful. The UE A sends 200OK in response to the MSRP REPORT message.

In accordance with various example embodiments of the present disclosure, the RTP stack is implementation of RTP protocol. The Real-time Transport Protocol (RTP) is a network protocol for delivering audio and video over IP networks. RTP is used in communication and entertainment systems that involve streaming media, such as telephony, video teleconference applications television services and web-based push-to-talk features. According to the implementations of the present disclosure, RTP stack is used for video and audio media exchange. The UE A sends RTP packet to UE B. the RTP packet carries audio/video stream data. Further, UE B sends RTCP packet to UE A. The real-time transport control protocol (RTCP) based data packet contains transmission statistics. Real-Time Transport Control Protocol (RTCP) is a protocol that works with Real-Time Protocol (RTP) to monitor data delivery on communication networks. Monitoring delivery may determine whether RTP is providing the necessary Quality of Service (QoS).

In accordance with various example embodiments of the present disclosure, the network interface (e.g., including interface circuitry) [218] is responsible for TCP/UDP/TLS (transmission control protocol/user datagram protocol/transport layer security) connections application programing interface (API), and for invoking system APIs to send request/responses. The network interface [218] comprises various connections/interface points, for example, for creating socket, connecting socket, disconnecting socket, reading data (or receiving communication data), and writing data (or sending communication data). For TCP Connect procedure, the UE A sends TCP synchronization (TCP SYN) message.

The server to UE A sends TCP synchronization acknowledgement (TCP SYN ACK) in response to the TCP SYN message. Further, the UE A sends TCP acknowledgement (TCP ACK) message to server. Similarly, for TCP disconnect procedure, the UE A sends TCP finish (TCP FIN) message. The server sends TCP finish acknowledgement (TCP FIN ACK) in response to the TCP FIN message. Further, the server sends TCP finish (TCP FIN) message to UE A. Further, the UE A sends TCP acknowledgement (TCP ACK) message to the server.

The present disclosure further discloses a non-transitory computer readable storage medium storing instructions for managing a rich communication service (RCS) based communication. The instructions include executable code which, when executed by one or more units of a system [100], causes a processing unit [102] of the system [100] to determine a set of network capabilities for a concurrent communication session and a rich communication service (RCS) session. Further, the executable code, when executed, causes the processing unit [102] to send a composer data comprising RCS information. Further, the executable code, when executed, causes the processing unit [102] to determine one or more service configuration rules related to the composer data. Further, the executable code, when executed, causes the processing unit [102] to manage the RCS based communication based on the composer data and the one or more service configuration rules.

Thus, the disclosure provides a novel way to address managing a rich communication service (RCS) based communication. The present disclosure provides a system that is able to transmit a composer service communication or RCS with desired information such as location sharing communication or conference information to a new user that is added to a call session. The present disclosure facilitates determination of the service configurations rules related to the composer service, pre-call communication and post call communication, for managing the RCS based communication. Further, the present disclosure provides a solution that can determine the service configuration rules specifying a desired action using a communication message. The present disclosure enables transmission and receiving of RCS messages at a remote device if a callee device has enabled communication forwarding rules to forward communication(s) to the remote device.

According to an embodiment, a method for managing a rich communication service (RCS) based communication, may comprise determining a set of network capabilities for a current communication session and a rich communication service (RCS) session, sending a composer data comprising RCS information, determining one or more service configuration rules related to the composer data, and managing the RCS based communication based on the composer data and the one or more service configuration rules.

For example, the composer data may specify a desired action.

For example, the one or more service configuration rules may bee related to at least one of a composer service, a pre-call communication, and a post-call communication.

For example, the one or more service configuration rules may comprise at least one of a call diversion rule, a call barring rule, a call line identity restriction rule, and a call waiting rule.

For example, the current communication session may occur among two or more user devices comprising at least a first user device, and a second user device. The set of network capabilities may comprise one or more parameters indicating an ability of the two or more user devices for an establishment of the current communication session and the RCS session.

For example, the set of network capabilities may be determined based on a performance of at least one of a query based technique and presence information based technique.

For example, the RCS information may comprise at least one of an agenda related information, an urgency related information, and an image, and the conference information comprises at least one of a conference focus related information, a number of participants, a name of the participants, a conference time, a conference duration, one or more conference admin rules, one or more participation rules, and one or more RCS rules.

For example, the composer data may be sent in a Session Initiation Protocol (SIP) REFER message.

For example, the method may comprise receiving a user response, in a Session Initiation Protocol (SIP) NOTIFY message, on at least one of the two or more devices.

According to an embodiment, A method for managing a rich communication service (RCS) based communication in a multi-party call, may comprise detecting a communication session between a first user device and a second user device, determining a set of network capabilities for a concurrent communication session and a rich communication service (RCS) session, sending a multi-party call composer data comprising RCS information and conference information, determining one or more service configuration rules related to the multi-party call composer data, and managing the RCS based communication in the multi-party call based on the multi-party call composer data and the one or more service configuration rules.

For example, the multi-party call composer data may specify at least one of a desired action.

For example, the multi-party call may occur among three or more user devices comprising at least a first user device, a second user device, and a third user device. The set of network capabilities may comprise one or more parameters indicating an ability of the three or more user devices for an establishment of the concurrent communication session and the RCS session.

For example, the method may comprise sending a call invite to a fourth user device among the three or more user devices to establish a concurrent communication session with the fourth user device based on a service configuration rule among the one or more service configuration rules configured at the third user device.

For example, for establishing the concurrent communication session with the fourth user device, the method may comprise initiating a communication for adding the fourth user device in the communication session between the first user device and the second user device.

For example, the method may comprise receiving a user response, in a Session Initiation Protocol (SIP) NOTIFY message, on at least one of the first user device, the second user device, and the third user device from the fourth user device, in response to the communication initiated for adding the fourth user device in the communication session.

For example, the multi-party call composer data may be sent in a Session Initiation Protocol (SIP) REFER message.

For example, the set of network capabilities may be determined based on a performance of at least one of a query based technique and presence information based technique.

For example the RCS information may comprise at least one of an agenda related information, an urgency related information, and an image, and the conference information comprises at least one of a conference focus related information, a number of participants, a name of the participants, a conference time, a conference duration, one or more conference admin rules, one or more participation rules, and one or more RCS rules.

According to an embodiment, a system for managing a rich communication service (RCS) based communication, comprises at least one processor comprising processing circuitry, and a memory connected to at least one processor, The at least one processor, individually and/or collectively, may be configured to cause the system to determine a set of network capabilities for a current communication session and a rich communication service (RCS) session, send a composer data comprising RCS information, determine one or more service configuration rules related to the composer data, and manage the RCS based communication based on the composer data and the one or more service configuration rules.

According to an embodiment, a method for managing a rich communication service (RCS) based communication, may comprise determining a set of network capabilities for a communication session and a rich communication service (RCS) session, transmitting a composer information comprising RCS information, determining one or more service configuration rules related to the composer information, and managing the RCS based communication based on the composer information and the one or more service configuration rules.

For example, the composer information may specify a desired action.

For example, the one or more service configuration rules may be related to at least one of a composer service, a pre-call communication, and a post-call communication.

For example, the one or more service configuration rules may comprise at least one of a call diversion rule, a call barring rule, a call line identity restriction rule, and a call waiting rule.

For example, the communication session may occur among two or more user devices comprising at least a first user device, and a second user device. The set of network capabilities may comprise one or more parameters indicating an ability of the two or more user devices for an establishment of the communication session and the RCS session.

For example, the set of network capabilities may be determined based on a performance of at least one of a query based technique and presence information based technique.

For example, the RCS information may comprise at least one of an agenda related information, an urgency related information, and an image, and the conference information comprises at least one of a conference focus related information, a number of participants, a name of the participants, a conference time, a conference duration, one or more conference admin rules, one or more participation rules, and one or more RCS rules.

For example, the composer information may be transmitted by a Session Initiation Protocol (SIP) REFER message.

For example, the method may comprise receiving a user response, in a Session Initiation Protocol (SIP) NOTIFY message, on at least one of the two or more devices.

According to an embodiment, an electronic device for managing a rich communication service (RCS) based communication, may comprise communication circuitry, at least one processor comprising processing circuitry, and memory comprising one or more storage media, storing instructions. The instructions, when executed by the at least one processor, may cause the electronic device to determine a set of network capabilities for a communication session and a rich communication, transmit a composer information comprising RCS information, determine one or more service configuration rules related to the composer information, and manage the RCS based communication based on the composer information and the one or more service configuration rules.

For example, the composer information may specify a desired action.

For example, the one or more service configuration rules may be related to at least one of a composer service, a pre-call communication, and a post-call communication.

For example, the one or more service configuration rules may comprise at least one of a call diversion rule, a call barring rule, a call line identity restriction rule, and a call waiting rule.

For example, the communication session may occur among two or more user devices comprising at least a first user device, and a second user device. The set of network capabilities may comprise one or more parameters indicating an ability of the two or more user devices for an establishment of the communication session and the RCS session.

For example, the set of network capabilities may be determined based on a performance of at least one of a query based technique and presence information based technique.

For example, the RCS information may comprise at least one of an agenda related information, an urgency related information, and an image, and the conference information comprises at least one of a conference focus related information, a number of participants, a name of the participants, a conference time, a conference duration, one or more conference admin rules, one or more participation rules, and one or more RCS rules.

For example, the composer information may be transmitted by a Session Initiation Protocol (SIP) REFER message.

For example, the instructions, when executed by the at least one processor, may cause the electronic device to receive a user response, in a Session Initiation Protocol (SIP) NOTIFY message, on at least one of the two or more devices.

According to an embodiment, a non-transitory computer readable storage medium may store one or more programs. The one or more programs include instructions, when executed by at least one processor of an electronic device with communication circuitry, may cause the electronic device to determine a set of network capabilities for a communication session and a rich communication, transmit a composer information comprising RCS information, determine one or more service configuration rules related to the composer information, and manage the RCS based communication based on the composer information and the one or more service configuration rules.

For example, the composer information may specify a desired action.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

For one or more embodiments, at least one of the components set forth in one or more of the preceding figures may be configured to perform one or more operations, techniques, processes, and/or methods as set forth herein. For example, a processor (e.g., baseband processor) as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

The methods according to various embodiments described in the claims and/or the specification of the disclosure may be implemented in hardware, software, or a combination of hardware and software.

When implemented by software, a computer-readable storage medium storing one or more programs (software modules) may be provided. One or more programs stored in such a computer-readable storage medium (e.g., non-transitory storage medium) are configured for execution by one or more processors in an electronic device. The one or more programs include instructions that cause the electronic device to execute the methods according to embodiments described in the claims or specification of the disclosure.

Such a program (e.g., software module, software) may be stored in a random-access memory, a non-volatile memory including a flash memory, a read only memory (ROM), an electrically erasable programmable read only memory (EEPROM), a magnetic disc storage device, a compact disc-ROM (CD-ROM), digital versatile discs (DVDs), other types of optical storage devices, or magnetic cassettes. Alternatively, it may be stored in a memory configured with a combination of some or all of the above. In addition, respective constituent memories may be provided in a multiple number.

Further, the program may be stored in an attachable storage device that can be accessed via a communication network, such as e.g., Internet, Intranet, local area network (LAN), wide area network (WAN), or storage area network (SAN), or a communication network configured with a combination thereof. Such a storage device may access an apparatus performing an embodiment of the disclosure through an external port. Further, a separate storage device on the communication network may be accessed to an apparatus performing an embodiment of the disclosure.

In the above-described specific embodiments of the disclosure, a component included therein may be expressed in a singular or plural form according to a proposed specific embodiment. However, such a singular or plural expression may be selected appropriately for the presented context for the convenience of description, and the disclosure is not limited to the singular form or the plural elements. Therefore, either an element expressed in the plural form may be formed of a singular element, or an element expressed in the singular form may be formed of plural elements.

Meanwhile, specific embodiments have been described in the detailed description of the disclosure, but it goes without saying that various modifications are possible without departing from the scope of the disclosure.

What is claimed is:

1. A method for managing a rich communication service (RCS) based communication, the method comprising:
determining a set of network capabilities for a communication session and a rich communication service (RCS) session;
transmitting a composer information comprising RCS information;
determining one or more service configuration rules related to the composer information; and
managing the RCS based communication based on the composer information and the one or more service configuration rules.

2. The method as claimed in claim 1, wherein the composer information specifies a desired action.

3. The method as claimed in claim 1, wherein the one or more service configuration rules are related to at least one of a composer service, a pre-call communication, and a post-call communication.

4. The method as claimed in claim 1, wherein the one or more service configuration rules comprises at least one of a call diversion rule, a call barring rule, a call line identity restriction rule, and a call waiting rule.

5. The method as claimed in claim 1, wherein the communication session occurs among two or more user devices comprising at least a first user device, and a second user device, and wherein the set of network capabilities comprises one or more parameters indicating an ability of the two or more user devices for an establishment of the communication session and the RCS session.

6. The method as claimed in claim 1, wherein the set of network capabilities are determined based on a performance of at least one of a query based technique and presence information based technique.

7. The method as claimed in claim 1, wherein the RCS information comprises at least one of an agenda related information, an urgency related information, and an image, and the conference information comprises at least one of a conference focus related information, a number of participants, a name of the participants, a conference time, a conference duration, one or more conference admin rules, one or more participation rules, and one or more RCS rules.

8. The method as claimed in claim 1, wherein the composer information is transmitted by a Session Initiation Protocol (SIP) REFER message.

9. The method as claimed in claim 5, wherein the method further comprises receiving a user response, in a Session Initiation Protocol (SIP) NOTIFY message, on at least one of the two or more devices.

10. An electronic device for managing a rich communication service (RCS) based communication, comprising:
communication circuitry;
at least one processor comprising processing circuitry, and
memory comprising one or more storage media, storing instructions,
wherein the instructions, when executed by the at least one processor, cause the electronic device to:
determine a set of network capabilities for a communication session and a rich communication;
transmit a composer information comprising RCS information;
determine one or more service configuration rules related to the composer information; and
manage the RCS based communication based on the composer information and the one or more service configuration rules.

11. The electronic device of claim 10, wherein the composer information specifies a desired action.

12. The electronic device of claim 10, wherein the one or more service configuration rules are related to at least one of a composer service, a pre-call communication, and a post-call communication.

13. The electronic device of claim 10, wherein the one or more service configuration rules comprises at least one of a call diversion rule, a call barring rule, a call line identity restriction rule, and a call waiting rule.

14. The electronic device of claim 10, wherein the communication session occurs among two or more user devices comprising at least a first user device, and a second user device, and wherein the set of network capabilities comprises one or more parameters indicating an ability of the two or more user devices for an establishment of the communication session and the RCS session.

15. The electronic device of claim 10, wherein the set of network capabilities are determined based on a performance of at least one of a query based technique and presence information based technique.

16. The electronic device of claim 10, wherein the RCS information comprises at least one of an agenda related information, an urgency related information, and an image, and the conference information comprises at least one of a conference focus related information, a number of participants, a name of the participants, a conference time, a conference duration, one or more conference admin rules, one or more participation rules, and one or more RCS rules.

17. The electronic device of claim 10, wherein the composer information is transmitted by a Session Initiation Protocol (SIP) REFER message.

18. The electronic device of claim 17, wherein the instructions, when executed by the at least one processor, cause the electronic device to:
receive a user response, in a Session Initiation Protocol (SIP) NOTIFY message, on at least one of the two or more devices.

19. A non-transitory computer readable storage medium storing one or more programs, wherein the one or more programs include instructions, when executed by at least one processor of an electronic device with communication circuitry, cause the electronic device to:
determine a set of network capabilities for a communication session and a rich communication;
transmit a composer information comprising RCS information;
determine one or more service configuration rules related to the composer information; and
manage the RCS based communication based on the composer information and the one or more service configuration rules.

20. The non-transitory computer readable storage medium of claim 19, wherein the composer information specifies a desired action.
